(19) United States
(12) Patent Application Publication
(10) Pub. No.: US 2022/0245534 A1
(43) Pub. Date: Aug. 4, 2022

(54) SYSTEM AND METHOD FOR DATA ANALYTICS WITH MULTI-STAGE FEATURE SELECTION

(71) Applicant: Chevron U.S.A. Inc., San Ramon, CA (US)

(72) Inventor: Julian A. Thorne, Houston, TX (US)

(21) Appl. No.: 17/164,062

(22) Filed: Feb. 1, 2021

(51) Int. Cl. G06Q 10/06; G06N 20/00

(52) U.S. Cl. CPC G06Q 10/067; G06N 20/00

(57) ABSTRACT

A method is described for data analytics including receiving a set of M variables representative of a subsurface volume of interest, derived from one or more of co-located well-log data, seismic data, and production data; performing a global optimum branch-and-bound algorithm to find a collection of N variables from the set of M variables that achieve the best fit in multiple regression; adding random variables to the collection of N variables; a slightly non-linear optimization until a statistically significant percentage of the random variables are eliminated; and performing, a highly non-linear optimization to select a final set of features. The method may be executed by a computer system.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The disclosed embodiments relate generally to techniques for data analytics and, in particular, to a method of data analytics with multi-stage feature selection.

### BACKGROUND

Data analytics, alternatively called data mining or data science, uses optimization methods to fit non-linear functions of explanatory variables to a response variable. Since these methods are so non-linear, spurious correlations are an inevitable outcome of this process if there are many features in the function. To mitigate this problem, a process called feature selection is employed. In feature selection, explanatory variables are removed from the function one at a time depending on which is the least statistically significant. If the fit with fewer features is better than the fit with many features, then feature selection has improved the process. Unfortunately, there are many issues with the current state-of-the-art feature selection process. First, the process of removing one variable at a time is a greedy optimization process that in no way guarantees a global optimum solution. Second, when a large number of features in the mix are actually random and have no statistical significance, the process is confused by the presence of these random variables.

There is an opportunity to optimize feature selection in order to improve data analytics.

### SUMMARY

In accordance with some embodiments, a method of data analytics including receiving a set of M variables representative of a subsurface volume of interest, derived from one or more of co-located well-log data, seismic data, and production data; performing a global optimum branch-and-bound algorithm to find a collection of N variables from the set of M variables that achieve the best fit in multiple regression; adding random variables to the collection of N variables; a slightly non-linear optimization until a statistically significant percentage of the random variables are eliminated; and performing, a highly non-linear optimization to select a final set of features is disclosed. The method may use the final set of features to predict hydrocarbon production.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates a flowchart of a method of data analytics, in accordance with some embodiments; and

FIG. 2 is a block diagram illustrating a data analytics system, in accordance with some embodiments.

Like reference numerals refer to corresponding parts throughout the drawings.

### DETAILED DESCRIPTION OF EMBODIMENTS

Described below are methods, systems, and computer readable storage media that provide a manner of data analytics. The data analytics methods and systems provided herein may be used for prediction of hydrocarbon production.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

Hydrocarbon exploration and production results in a huge amount of data. This may include geological data, geophysical data, and petrophysical data. It may also include production data. Data analytics can extract meaning from this data in order to make predictions for identifying and producing hydrocarbons. For example, well-log petrophysical data and seismic attributes can be used to predict the observed variations in gas or oil production across a field or basin. Data analytic tools such as an ensemble of regression or classification decision trees can be trained on co-located well-logs, seismic, and production data to generate a prediction function. The prediction function is then applied on interpolated petrophysical property maps or volumes and the seismic attributes to predict the desired response variables such as estimated ultimate recovery. Since well completion parameters can also influence production, data analytics is also used to normalize out these effects.

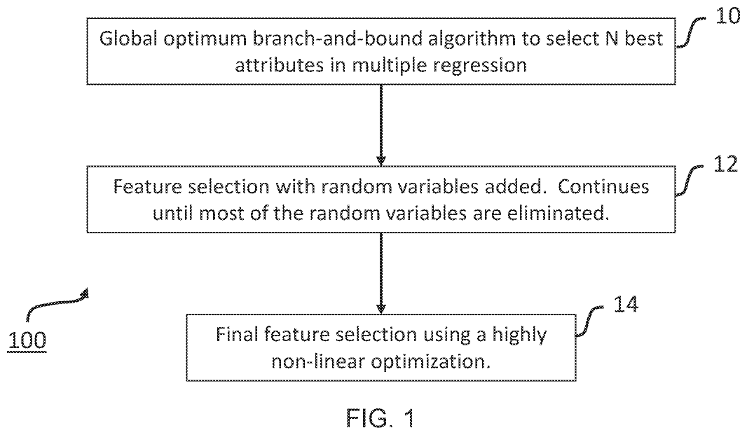

In the present invention, the current state-of-the-art feature selection process is replaced by a three-stage process that addresses the issues described earlier. Referring to FIG. 1 which illustrates the method 100, in the first stage 10 a global optimum branch-and-bound algorithm is used to find the collection of N variables from the original set of M variables that achieve the best fit in multiple regression. This algorithm is guaranteed to find a global optimum because it makes use of the facts that in linear regression adding an additional variable will always improve the final solution or not change it at all. In the second stage 12 of the feature selection process, random variables are added to the mix of features. The function that is optimized is changed from linear to slightly nonlinear. For example, if a boosted regression tree is used the number of learning stages can be set to 1 rather than a higher number. Since the degree of nonlinearity increases with the number of learning stages using only 1 learning stage creates a slightly non-linear function. A highly complex nonlinear function is not allowed. This allows the process not to be confused by random variables. Feature selection continues until the random variables are mostly eliminated. In practice because there is a statistically probable chance that even a random variable can be, by chance, significant, the process continues until a certain statistically significant percentage of the random variables are eliminated rather than totally eliminated. The required percentage is the familiar confidence level used to test any statistical hypothesis. In the third stage 14 of the feature selection process, the function to be optimized is changed to a highly nonlinear one for the final feature selection. This allows the process, given sufficient safeguards involving cross-validation, to fit a complex response function. For example, a gradient boosted regression or decision tree with many learning stages can create a highly non-linear function. Cross-validation should follow the established practices of splitting the data into training, testing and validation sets. In data science practice, the splitting between training and testing data is done many times with different splits.

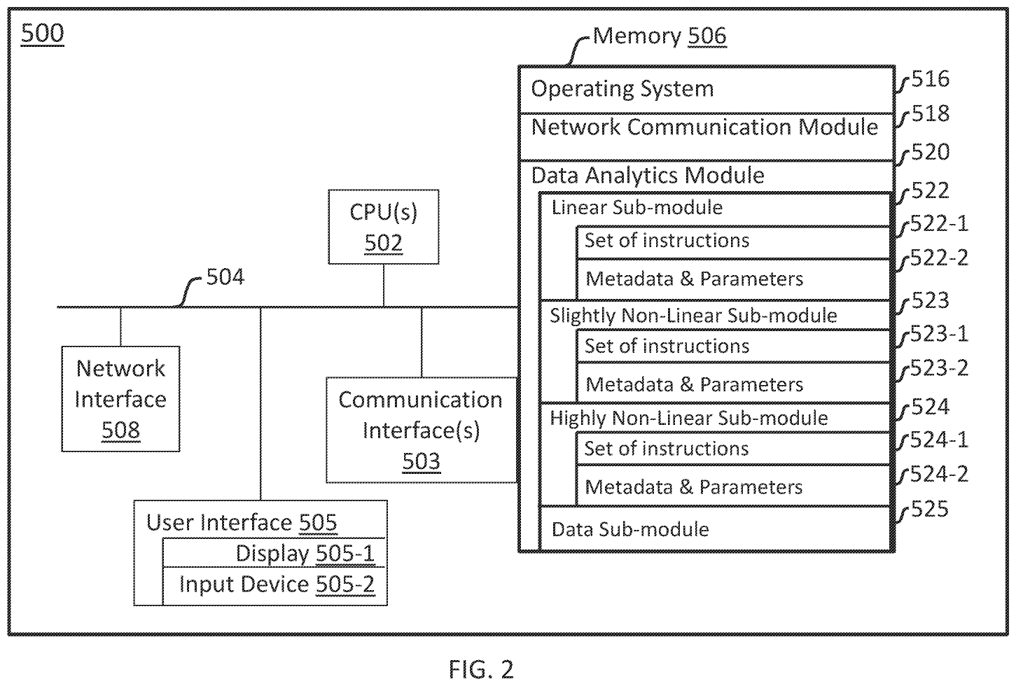

FIG. 2 is a block diagram illustrating a data analytics system 500, in accordance with some embodiments. While certain specific features are illustrated, those skilled in the art will appreciate from the present disclosure that various other features have not been illustrated for the sake of brevity and so as not to obscure more pertinent aspects of the embodiments disclosed herein.

To that end, the data analytics system 500 includes one or more processing units (CPUs) 502, one or more network interfaces 508 and/or other communications interfaces 503, memory 506, and one or more communication buses 504 for interconnecting these and various other components. The data analytics system 500 also includes a user interface 505 (e.g., a display 505-1 and an input device 505-2). The communication buses 504 may include circuitry (sometimes called a chipset) that interconnects and controls communications between system components. Memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the CPUs 502. Memory 506, including the non-volatile and volatile memory devices within memory 506, comprises a non-transitory computer readable storage medium and may store, for example, geophysical data, geologic data, petrophysical data, and/or production data.

In some embodiments, memory 506 or the non-transitory computer readable storage medium of memory 506 stores the following programs, modules and data structures, or a subset thereof including an operating system 516, a network communication module 518, and a data analytics module 520.

The operating system 516 includes procedures for handling various basic system services and for performing hardware dependent tasks.

The network communication module 518 facilitates communication with other devices via the communication network interfaces 508 (wired or wireless) and one or more communication networks, such as the Internet, other wide area networks, local area networks, metropolitan area networks, and so on. The data analytics system 500 may be on a single device, multiple devices in a cluster, and/or be a cloud computing system.

In some embodiments, the data analytics module 520 executes the operations disclosed herein. Data analytics module 520 may include data sub-module 525, which handles the dataset including all available geological, geophysical, petrophysical, and production data. This data is supplied by data sub-module 525 to other sub-modules.

Linear sub-module 522 contains a set of instructions 522-1 and accepts metadata and parameters 522-2 that will enable it to perform stage 10 of method 100. The slightly non-linear sub-module 523 contains a set of instructions 523-1 and accepts metadata and parameters 523-2 that will enable it to perform stage 12 of method 100. The highly non-linear sub-module 523 contains a set of instructions 524-1 and accepts metadata and parameters 524-2 that will enable it to perform stage 14 of method 100. Although specific operations have been identified for the sub-modules discussed herein, this is not meant to be limiting. Each sub-module may be configured to execute operations identified as being a part of other sub-modules, and may contain other instructions, metadata, and parameters that allow it to execute other operations of use in processing data and generating images. For example, any of the sub-modules may optionally be able to generate a display that would be sent to and shown on the user interface display 505-1. In addition, any of the data or processed data products may be transmitted via the communication interface(s) 503 or the network interface 508 and may be stored in memory 506.

Method 100 is, optionally, governed by instructions that are stored in computer memory or a non-transitory computer readable storage medium (e.g., memory 506 in FIG. 2) and are executed by one or more processors (e.g., processors 502) of one or more computer systems. The computer readable storage medium may include a magnetic or optical disk storage device, solid state storage devices such as flash memory, or other non-volatile memory device or devices. The computer readable instructions stored on the computer readable storage medium may include one or more of: source code, assembly language code, object code, or another instruction format that is interpreted by one or more processors. In various embodiments, some operations in each method may be combined and/or the order of some operations may be changed from the order shown in the figures. For ease of explanation, method 100 is described as being performed by a computer system, although in some embodiments, various operations of method 100 are distributed across separate computer systems.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of data analytics, comprising:
a. receiving, at one or more computer processors, a set of M variables representative of a subsurface volume of interest;
b. performing, via the one or more computer processors, a global optimum branch-and-bound algorithm to find a collection of N variables from the set of M variables that achieve the best fit in multiple regression;
c. adding, via the one or more computer processors, random variables to the collection of N variables;
d. performing, via the one or more computer processors, a slightly non-linear optimization until a statistically significant percentage of the random variables are eliminated; and
e. performing, via the one or more computer processors, a highly non-linear optimization to select a final set of features.

2. The method of claim 1 wherein the final set of features fit a complex response function.

3. The method of claim 1 further comprising using the final set of features to predict hydrocarbon production.

4. The method of claim 1 wherein the set of M variables is derived from one or more of co-located well-log data, seismic data, and production data.

5. The method of claim 1 wherein the slightly non-linear optimization is a boosted regression tree with 1 learning stage.

6. The method of claim 1 wherein the highly non-linear optimization is a gradient boosted regression or a decision tree with many learning stages.

7. The method of claim 1 wherein the highly non-linear optimization uses cross-validation.

8. A computer system, comprising:
one or more processors;
memory; and
one or more programs, wherein the one or more programs are stored in the memory and configured to be executed by the one or more processors, the one or more programs including instructions that when executed by the one or more processors cause the system to:
a. receive, at the one or more processors, a set of M variables representative of a subsurface volume of interest;
b. perform, via the one or more processors, a global optimum branch-and-bound algorithm to find a collection of N variables from the set of M variables that achieve the best fit in multiple regression;
c. add, via the one or more processors, random variables to the collection of N variables;
d. perform, via the one or more processors, a slightly non-linear optimization until a statistically significant percentage of the random variables are eliminated; and
e. perform, via the one or more processors, a highly non-linear optimization to select a final set of features.

9. The system of claim 8 wherein the final set of features fit a complex response function.

10. The system of claim 8 further comprising using the final set of features to predict hydrocarbon production.

11. The system of claim 8 wherein the set of M variables is derived from one or more of co-located well-log data, seismic data, and production data.

12. The system of claim 8 wherein the slightly non-linear optimization is a boosted regression tree with one learning stage.

13. The system of claim 8 wherein the highly non-linear optimization is a gradient boosted regression or a decision tree with many learning stages.

14. The system of claim 8 wherein the highly non-linear optimization uses cross-validation.

15. A non-transitory computer readable storage medium storing one or more programs, the one or more programs comprising instructions, which when executed by an electronic device with one or more processors and memory, cause the device to:
a. receive, at the one or more processors, a set of M variables representative of a subsurface volume of interest;
b. perform, via the one or more processors, a global optimum branch-and-bound algorithm to find a collection of N variables from the set of M variables that achieve the best fit in multiple regression;
c. add, via the one or more processors, random variables to the collection of N variables;
d. perform, via the one or more processors, a slightly non-linear optimization until a statistically significant percentage of the random variables are eliminated; and
e. perform, via the one or more processors, a highly non-linear optimization to select a final set of features.
